(19) United States
(12) Patent Application Publication
(10) Pub. No.: US 2014/0320378 A1
(43) Pub. Date: Oct. 30, 2014

(54) THREE DIMENSIONAL SELF-FOLDED MICROANTENNA

(71) Applicant: The Johns Hopkins University, Baltimore, MD (US)

(72) Inventors: David H. Gracias, Baltimore, MD (US); Evin Gultepe, Baltimore, MD (US); Paulo Mateus Mendes, Braga (PT); Pedro Alexandre Marques Anacleto, Baltimore, MD (US)

(73) Assignee: The Johns Hopkins University, Baltimore, MD (US)

(21) Appl. No.: 13/874,079

(22) Filed: Apr. 30, 2013

(51) Int. Cl. H01Q 1/36; H01Q 21/00

(52) U.S. Cl. CPC H01Q 1/364; H01Q 21/00
USPC 343/893; 343/700 MS

(57) ABSTRACT

Three-dimensional (3D) devices that can receive, harvest or transmit electromagnetic energy with increased efficiency as compared to planar, two-dimensional devices, and methods of making thereof, are disclosed.

### FEDERALLY SPONSORED RESEARCH OR DEVELOPMENT

This invention was made with government support under W911NF-09-2-0065 awarded by the Army Research Office. The government has certain rights in the invention.

### BACKGROUND

The implantable devices market is expected to exceed $50 billion in 2015 in the U.S. alone (Biomat.net Newsletter, 2011), with an 8% yearly growth rate due to new implantable solutions for treating and monitoring a wide range of health-related problems including, but not limited to, cardiovascular, neurological, orthopedic, and ophthalmological disorders. The increasing number of implantable devices and the resulting growing market are partially due to innovations in the field of miniaturization at the individual component level. Implantable devices are becoming smaller and smaller and can perform tasks that are only possible because of their miniaturized dimensions. Many implantable solutions, such as blood pressure and blood glucose monitoring devices (Peng et al., 2009; Ahmadi and Jullien, 2009), ECG monitoring (Fu et al., 2011), cardioverter defibrillator (Lee et al., 2009), cardiovascular stents (Chow et al., 2009), neural probes (Wise et al., 2008), retinal prosthesis (Miura et al., 2011), glaucoma pressure monitoring devices (Chow et al., 2010), miniaturized medical tools (Randall et al., 2012), and drug delivery systems (Rahimi et al., 2011; Yang et al., 2009), are now available and have the capability to significantly improve patients' quality of life.

In addition to medical devices, small networked and wireless devices, such as cellular phones, surveillance and communication systems, smart devices, and RFID systems, often require microantenna structures for transmitting and receiving signals and operating electronic modules.

Batteries currently are the main source of power for implantable medical and miniaturized network or communication devices. Significant achievements in battery technology have made it possible to have high energy density batteries, such as lithium-ion batteries, that are able to maintain almost constant voltage until they are discharged to 75% to 80%. In spite of these technological advancements, however, batteries still increase the size of implants considerably, thereby limiting the further miniaturization of the devices. Also, batteries eventually require replacement, which can be expensive or, in some cases, undesirable or impracticable.

### SUMMARY

The presently disclosed subject matter provides three-dimensional (3D) devices, e.g., an antenna structure, that can receive, harvest or transmit electromagnetic energy with increased efficiency as compared to planar, two-dimensional devices.

In some aspects, the presently disclosed subject matter provides an antenna structure comprising a plurality of interconnected two-dimensional metallic or semiconducting elements folded around or otherwise enveloping a sub-millimeter scale dielectric polyhedron or sub-millimeter scale particle.

In particular aspects, the self-folding is achieved through the surface tension of one or more hinges comprising any liquefiable or coalescing material, a result of extrinsic stresses that develop due to grain coalescence in thin films upon heating after deposition, or through hinges comprising residually stressed bilayers, thermally stressed bilayers, stimuli responsive materials, polymer bilayers, and polymer gradients.

In other aspects, the presently disclosed subject matter provides an implantable medical device or networked sensor comprising the presently disclosed antenna structure.

In yet other aspects, the presently disclosed subject matter provides an electronic device comprising the presently disclosed antenna structure.

In further aspects, the presently disclosed subject matter provides an array comprising a plurality of the presently disclosed antenna structures.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which are not necessarily drawn to scale, and wherein:

FIG. 1 shows an embodiment of an HFSS model of a square loop antenna in a 500×500×500 μm³ box;

FIGS. 2A and 2B show a simulated radiation pattern of a square loop antenna at 5 GHz: (2A) in free space, and (2B) when embedded in a 5×5×5 mm³ human muscle tissue layer;

FIG. 3 shows the link efficiency of 500×500 μm² square loop antenna embedded in 5×5 x×5 mm³ volume of human muscle tissue and the necessary RF power at the input of a transmitting antenna, to deliver 1 μW power to a microdevice powered by such antenna;

FIG. 4 shows an embodiment of a HFSS model of a gold cubic shape antenna enveloping a 500×500×500 μm³ microdevice;

FIGS. 5A and 5B show the radiation patterns of the cubic shape antenna: (5A) in free space, and (5B) when embedded in a 5×5×5 mm³ human muscle tissue layer;

FIG. 6 shows the link efficiency of a cubic antenna in 5×5×5 mm³ human muscle tissue and external RF power, at the input of a transmitting antenna required to transfer 1 μW power to it;

FIGS. 7A and 7B show a three-dimensional (3D) small antenna prototype: (7A) schematic of a two-dimensional (2D) template of the small antenna before self-folding, and (7B) optical microscopy images of 500×500×500 μm³ cubic shape, 3D antenna prototype;

FIGS. 8A-8F show representative embodiments of microantenna structures;

FIGS. 9A-9F show representative embodiments of microantenna structures;

FIGS. 10A-10D show representative embodiments of microantenna structures;

FIGS. 11A-11D show representative embodiments of microantenna structures; and

FIGS. 12A-12C show representative embodiments of microantenna structures.

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

### I. Three Dimensional (3D) Self-Folded Microantenna

### A. Overview: Energy Sources for Implantable Devices

A solution to overcome limitations presented by batteries as a source for supplying power to implanted medical devices or networked sensors relies on creating energy harvesting systems that can use natural or artificial sources of energy. Several techniques for energy harvesting and remote powering for implantable devices, such as kinetic harvesters, thermoelectric effect scavengers, fuel cells, and rectennas, can be found in the literature (Olivo et al., 2011).

With wireless technology enabling new remote applications, medical data can be collected by an implantable device and communicated wirelessly to an external receiver, allowing physicians to conduct instant and more accurate diagnosis (Yang et al., 2012). This key feature of implantable devices is made possible by battery-free, ultra-low power designs (Ahmadi and Jullien, 2009; Nuxoll and Siegel, 2009; Poon et al., 2010) and energy harvesting techniques that together contribute for smaller size implants with extended operational life times. These systems play a key role in the industry allowing biocompatible, battery-free, minimally invasive implantable medical devices.

One of these sources of energy, electromagnetic (EM) radiation, is accessible virtually everywhere. Powering an implanted medical device with EM has been a promising technology to eliminate the dependency on wired transfer or energy storage (Jabbar et al., 2010; Nishimoto et al., 2010; Huang et al., 2011). Energy harvesting from EM waves to power small, implantable devices, however, has proven challenging since it requires an electrically small antenna with severely constrained efficiency due to the constraints of extreme miniaturization (Yekeh and Kohno, 2007). The ratio of the antenna size to the resonant wavelength is the primary factor in establishing its performance characteristics, i.e., gain and efficiency, and hence, the amount of power it supplies to the device.

### B. Three-Dimensional (3D) Devices for Receiving, Harvesting, or Transmitting Electromagnetic Energy

In some embodiments, the presently disclosed subject matter provides methods for assembling three-dimensional (3D) devices that can receive, harvest, or transmit electromagnetic energy with increased efficiency as compared to planar, two-dimensional devices.

As used herein, the term “three-dimensional,” which can be abbreviated as “3D,” refers to a figure, an object, or an area that has a height, a width, and a depth. In contrast, the term “two-dimensional,” which can be abbreviated as “2D,” refers to a figure, an object, or an area that has a height and a width, but no depth, and is therefore flat or planar.

The presently disclosed 3D devices exhibit electromagnetic energy transfer with enhanced efficiency, lower power loss, and smaller form factors as compared to planar devices. The presently disclosed 3D devices can be used for wireless transmission and harvesting devices that require small overall device sizes for defense and biomedical implants, as well as other applications requiring such devices.

More particularly, in some embodiments, the presently disclosed subject matter provides a three-dimensional (3D) small microantenna suitable for energy harvesting applications in the low gigahertz regime to supply at least 1 μW power and fed by an electromagnetic wave from an external source to small, implantable medical devices. The presently disclosed micro antennas can be fabricated by combining planar photolithography and surface tension driven self-folding techniques to achieve the desired 3D profile.

Accordingly, the presently disclosed subject matter provides for the mass fabrication of untethered, free-standing, polyhedral microantenna structures. Such structures can be formed from the surface-tension-based self-assembly of two-dimensional precursor templates. As used herein, the term “self-assembly” refers to the spontaneous assembly of interacting precursor templates to form well-ordered nano- or microstructures.

As used herein, the terms “nanoscale” or “nanostructure” refer to one or more structures that have at least one dimension, e.g., a height, width, length, and/or depth, in a range from about one nanometer (nm), i.e., 1×10⁻⁹ meters, to about 999 nm, including any integer value, and fractional values thereof, including about 1, 2, 5, 10, 20, 30, 40, 50, 60, 70, 80, 90, 100, 200, 500, 600, 700, 800, 900, 999 nm and the like.

As used herein, the term “microscale” or “microstructure” refers to one or more structures that have at least one dimension in a range from about one micrometer (μm), i.e., 1×10⁻⁶ meters, to about 999 μm, including any integer value, and fractional values thereof, including about 1, 2, 5, 10, 20, 30, 40, 50, 60, 70, 80, 90, 100, 200, 500, 600, 700, 800, 900, 999 μm and the like.

As used herein, the terms “self-assemble” or “self-assembly” are used to distinguish from those cases in which each structural component is individually positioned into the final configuration. In contrast, a plurality of the presently disclosed nano- or microstructures can self-assemble in parallel by subjecting a plurality of templates to a proper environmental condition, such as temperature or a stress, at the same time. See U.S. Patent Application Publication No. 20130095258 for Array Structures of Containers to Gracias et al., published Apr. 18, 2013, which is incorporated by reference in its entirety.

In such self-assembling processes, the presently disclosed structures can comprise hinges, which, in some embodiments, comprise fluidic hinges that are self-folding and, when actuated, fold to form a polyhedral structure. In some embodiments, the polyhedral structure can be sealed or otherwise enclosed by interconnected metallic or semiconducting elements comprising locking hinges. As provided in more detail herein below, the presently disclosed methods incorporate one or more sacrificial layers, which can be removed (e.g., developed) to completely release the three-dimensional structures from a substrate upon which the metallic precursor templates of the structures are formed.

The presently disclosed nanostructures can have or be adapted to have any polyhedral shape. As used herein, the term “polyhedral” refers to of or relating to, or resembling a polyhedron. The term “polyhedron” refers to a three-dimensional object bounded by plane polygons or faces. The term “polygon” refers to a multisided geometric figure that is bound by many straight lines, including, but not limited to, a triangle, a square, a pentagon, a hexagon, a heptagon, an octagon, and the like. For example, the presently disclosed nano- or microstructures, in some embodiments, can be a cube. A cube is a three-dimensional object bounded by six square faces or sides, with three sides meeting at each vertex, i.e., a corner. In other embodiments, the nano- or microstructure can be a pyramid.

By using electron-beam lithography in conjunction with the property of self-assembly, polyhedral structures having at least one dimension ranging from about 100 nm to sub-millimeter (e.g., 999 μm or smaller) can be fabricated. One of ordinary skill in the art would appreciate that structures patterned on two-dimensional substrates by any method, including, but not limited to, electron-beam lithography and imprint lithography, can be assembled into the presently disclosed three-dimensional nanostructures.

Further, one or more faces of the polyhedral structure can be patterned with one or more nano- or microscale features having a line width as small as about fifteen nanometers. As used herein, the terms “patterned” and grammatical variants thereof, are used interchangeably and refer to any arbitrary two-dimensional pattern having nano- or microscale features, i.e., features having at least one dimension, e.g., a height, width, length, and/or depth, in a range from about one nm to about 999 μm, as those ranges are defined herein below. In some embodiments, the two-dimensional pattern can have a sub-nanometer dimension, i.e., a dimension having a range from about 0.1 nm to about 0.999 nm.

The nano- or microscale features can, in some embodiments, include perforations or pores, for example, an array of nano- or microscale holes, and/or a three-dimensional pattern, for example, a line or curvilinear structure having a width, height, and length, or other patterned 3D structure. These perforations, pores, and three-dimensional patterns can be created photolithographically, electrolithographically, or by using electron-beam lithography. Such perforations or pores can have a dimension ranging from about 0.1 nm to about 100 nm and, in some embodiments, can have a dimension from about 10 nm to about 50 nm.

The terms “photolithography,” “photo-lithography,” or “photolithographic process” refer to a lithographic technique in which precise patterns are created on a substrate, such as a metal or a resin, through the use of photographically-produced masks. Typically, a substrate is coated with a photoresist film, which is dried or hardened, and then exposed through irradiation by light, such as ultraviolet light, shining through the photomask. The unprotected areas then are removed, usually through etching, e.g., plasma etching or wet chemical etching, which leaves the desired patterns.

Further, the presently disclosed assembly process can be used with patterned, multilayer panels or elements comprising dissimilar materials. For example, the panels can be patterned with gold (Au), for example, curvilinear Au features having line widths as small as 15 nm. The presently disclosed structures also represent attractive building blocks for hierarchical self-assembly of nano- or microstructured three-dimensional devices.

The presently disclosed microantenna structures can be fabricated using methods for self-folding and self-assembling three-dimensional structures from two-dimensional templates disclosed in U.S. Pat. Nos. 8,246,917 and 8,236,259, each of which is incorporated by reference in its entirety.

Briefly, the fabrication process involves the self-assembly of a two dimensional (2D) metallic or semiconducting template into a 3D structure. First, 2D metallic or semiconducting templates are photolithographically patterned. A second layer of photolithography is used to pattern solder hinges on the outer edges and in between the faces of the templates. The 2D template spontaneously folds into the 3D structure when heated (for example, heated in a fluid) above the melting point of the hinges, wherein the surface tension of the molten hinge material provides the force to drive self-assembly.

The size of the 3D structure can be varied by patterning the 2D template appropriately. In some embodiments, the structures can be fabricated from nickel (Ni) and the outer and inner surfaces of the structures can be coated with gold (Au) to increase biocompatibility and decrease electrical resistance (low electrical resistance increases the skin depth for penetration of electromagnetic waves). The fabrication process is highly parallel and a large number of structures can be fabricated in a cost-effective manner.

More particularly, a polymeric sacrificial layer is spin-coated onto a silicon (Si) substrate to facilitate subsequent release of the 2D templates. A metal seed layer is then evaporated onto the sacrificial layer to create wafer-scale electrical contact for subsequent electrodeposition steps. The faces are patterned using photolithography and fabricated using electrodeposition. Since conventional photolithography is used to pattern faces, any arbitrary pattern can be incorporated. The choice of metals can be determined by cost, etch selectivity with respect to the seed layer, ease of deposition, and the need for functionality.

A second layer of photolithography is used to pattern the hinges. After hinge patterning, the exposed seed layer in the hinge region bounded by the faces was etched to disconnect the underlying seed layer only between the faces, while retaining electrical continuity with the rest of the seed layer at the face corners. The hinges are electrodeposited, and then the 2D template is released from the substrate by etching the remaining seed layer and dissolving the sacrificial layer. In one example, a template comprising six square faces arranged in a cruciform and held together by hinges can be used to form a cube. No other tether is necessary other than the hinge material between the faces. Self-folding can be carried out in a high boiling point solvent, e.g., N-methylpyrolidone (NMP), which is heated above the melting point of the hinge material.

The hinges of these structures comprise a material, including but not limited to, a metal, a solder (meaning an alloy formulated to have a specific melting point for use in joining metals), a metallic (meaning a metal or a mixture containing two or more metallic elements or metallic and nonmetallic elements usually fused together or dissolving into each other when molten), a polymer or a glass that can be liquefied, and combinations thereof. The surface tension of the liquid hinge provides the force necessary to fold the 2D template into the 3D particles.

In contrast with prior surface tension-based self-folding work, two types of hinges can be used to form the presently disclosed antenna structures: internal ones between faces (folding hinges) and external ones at the periphery of faces (locking hinges). Reflow of the folding hinges can provide the torque to rotate adjacent faces. Locking hinges that have the same length but half the width of the folding hinges play a secondary role in the folding of the 2D template; they function as a stabilizing stop, increase fault tolerance in folding, and ensure the desired final fold angle.

Further, in embodiments comprising locking hinges, the locking hinges increased the mechanical strength and sealed the edges of the polyhedra when two half-sized locking hinges fused and formed a single hinge containing, the equivalent volume of a folding hinge. Folding was complete within seconds when the locking hinges met and fused with each other. The fusion occurred as a result of the minimization of interfacial free energy between the molten locking solder hinge on each face and the surrounding liquid. On cooling, the solder hinges solidified and the polyhedral structure was locked in to place.

Once the nano- or microstructure is assembled, the environmental condition can be returned to its original condition, e.g., heat is removed and the structure is allowed to cool. Once cooled, the hinge becomes rigid and the structure is rigidly held together. Accordingly, the term “hinge” is not to be construed as always allowing movement of the structural components. The hinge also can be referred to as a joint and those terms are used interchangeably herein. Thus, the terms “hinge” or “joint” are intended to cover both a rigid joint, or a joint that compels movement of structural components. See U.S. Patent Application Publication No. 20130045530 for Self-Folding Sub-Centimeter Structures to Gracias et al., published Feb. 21, 2013, which is incorporated herein by reference in its entirety.

Thus, in some embodiments, a surface tension of the material comprising the one or more hinges provides the force necessary to fold the self-assembling 2D precursor templates into 3D nano- or microstructures. The hinges can comprise any liquefiable or coalescing material. In particular embodiments, the hinge comprises a material, including, but not limited to, a metal, a solder (meaning an alloy formulated to have a specific melting point for use in joining metals), a metallic (meaning a metal or a mixture containing two or more metallic elements or metallic and nonmetallic elements usually fused together or dissolving into each other when molten), a polymer, a glass that can be liquefied, and combinations thereof. In particular embodiments, the hinge comprises tin. See U.S. Patent Application Publication No. 20120135237 for Self-Assembly of Lithographically Patterned Polyhedral Nanostructures and Formation of Curving Nanostructures to Gracias et al., published May 31, 2012, which is incorporated herein by reference in its entirety.

In another embodiment, the force necessary to fold the self-assembling 2D precursor templates into 3D nano- or microstructures is a result of extrinsic stresses that develop due to grain coalescence in thin films upon heating after deposition. In such embodiments, the curved nano- or microstructure is actually hingeless. Such embodiments require only thermal evaporation and low temperature processing and the stress required for self-assembly can be controlled to occur only when desired. See U.S. Patent Application Publication No. 20120135237 for Self-Assembly of Lithographically Patterned Polyhedral Nanostructures and Formation of Curving Nanostructures to Gracias et al., published May 31, 2012, which is incorporated herein by reference in its entirety.

Self-folding also can be achieved with hinges comprising residually stressed bilayers, thermally stressed bilayers, stimuli responsive materials, such as N-isopropylacrylamide (NIPAM), polymer bilayers and polymer gradients. See Leong, T. G., et al, Thin film stress driven self-folding of microstructured containers, Small 4(10), 1605-1609 (2008); Gracias, D. H., Stimuli responsive self-folding using thin polymer films, Current Opinion in Chemical Engineering 2, 112-119 (2013), each of which is incorporated by reference in its entirety.

In some embodiments, on-demand, low temperature self-assembly can be accomplished by using hinges comprising a metallic bilayer to drive the assembly, coupled with a polymer layer that serves as the motion trigger. When heated or exposed to selected chemicals, mechanical property changes in the polymer trigger cause the stressed bimetallic layer to flex. See U.S. Patent Application Publication No. 20100326071 for Reconfigurable Lithographic Structures to Gracias et al., published Dec. 30, 2010; see also Leong, T. G., et al, Thin film stress driven self-folding of microstructured containers, Small 4(10), 1605-1609 (2008), each of which is incorporated herein by reference in its entirety.

In such embodiments, the hinge can comprise a bimetallic component, containing, for example, chromium (Cr) and copper (Cu), and a trigger made of, for example, photoresist polymer. In such embodiments, the self-folding is caused by stress that develops during thermal evaporation of the metal thin films. Without wishing to be bound to any one particular theory, the polymer layer prevents the bimetallic layer from spontaneously folding when the 2D template is released from the substrate at room temperature, and it allows on-demand folding when heated. The heating process softens the polymer trigger, which allowed the underlying bimetallic layer to relieve the residual stress by bending. See U.S. Patent Application Publication No. 20100326071 for Reconfigurable Lithographic Structures to Gracias et al., published Dec. 30, 2010; see also Leong, T. G., et al, Thin film stress driven self-folding of microstructured containers, Small 4(10), 1605-1609 (2008), each of which is incorporated herein by reference in its entirety.

In further embodiments, the nano- or microstructure can comprise a stimuli responsive self-folding structure using thin polymer films. Such structures, in some embodiments, can include polymer bilayers, wherein one or both layers are polymers. Curving or bending is achieved when one of the polymer layers contracts or swells more than the other, in response to a specific stimulus. In a non-limiting example, photolithographically patterned hydrogel actuators can be created by depositing photocrosslinked NIPAM derivatives atop other polymers such as PEGDA, to form pH and ionic strength responsive hinged hydrogel actuators. See Gracias, D. H., Stimuli responsive self-folding using thin polymer films, Current Opinion in Chemical Engineering 2, 112-119 (2013), which is incorporated by reference in its entirety.

In other embodiments, the self-folding structure uses a polymer with differential cross-linking along lateral dimensions or along its thickness. The concept of manipulating differential strain in a bilayer to drive stimuli responsive folding can be extended to a single chemically constituted polymer or gel by creating gradients or spatial heterogeneities within the film. Such heterogeneities can be generated by photocrosslinking variable concentrations of monomers or crosslinkers, doping with optically absorbent or photoactive molecules, and/or exposure to different intensities of ultraviolet light using optical filters or photomasks. Heterogeneities can either be created along lateral dimensions or along the thickness.

For example, it is possible to create cross-linking gradients along the thickness of a widely utilized photosensitive hydrophobic epoxy SU8 owing to its strong molecular absorbance at low ultraviolet wavelengths. By the use of photomasks and on conditioning such SU8 films, a variety of stimuli responsive structures, such as arrays of flower-like structures or metamaterial sheets can be created. Metamaterials are periodic materials, often composed of heterogeneous components with a large refractive index contrast, thus featuring novel electromagnetic properties. In some embodiments, the contrast can be achieved by patterning metallic resonators on a polymeric substrate, and the metamaterial sheets crumple or flatten out on solvent exchange, which induces solvation and desolvation of the films, and consequently reversible self-folding at differentially cross-linked hinges. See Gracias, D. H., Stimuli responsive self-folding using thin polymer films, Current Opinion in Chemical Engineering 2, 112-119 (2013), which is incorporated by reference in its entirety.

In yet other embodiments, as disclosed hereinabove, the self-assembled structures can use a polymer trigger atop a strained non-polymeric bilayer. Polymers, e.g., a polymer that is synthesized to degrade in response to specific chemicals, can be used as triggers atop pre-stressed inorganic bilayers, such as those composed of heteroepitaxially strained semiconductors or residually stressed metals. A polymer layer can be photopatterned atop a strained bilayer and as long as it is well adherent and stiff enough, it will arrest spontaneous self-folding of the underlying bilayer and can also render the folding stimuli responsive. Only in response to an appropriate stimulus, which can be a specific chemical that causes softening, degradation, dissolution or delamination of the polymer trigger, the energy in the underlying strained bilayer can be released causing it to actuate. See U.S. Patent Application Publication No. 20100326071 for Reconfigurable Lithographic Structures to Gracias et al., published Dec. 30, 2010; Gracias, D. H., Stimuli responsive self-folding using thin polymer films, Current Opinion in Chemical Engineering 2, 112-119 (2013), each of which is incorporated by reference in its entirety.

Accordingly, in some embodiments, the presently disclosed subject matter provides an antenna structure comprising a plurality of interconnected two-dimensional metallic or semiconducting elements folded around or otherwise enveloping a sub-millimeter scale dielectric polyhedron or sub-millimeter scale particle.

In some embodiments, the plurality of interconnected two-dimensional metallic or semiconducting elements comprise a folding hinge between two adjacent metallic or semiconducting elements and optionally a locking hinge on an edge of a metallic or semiconducting element, wherein the folding hinge between two adjacent metallic or semiconducting elements has a width that is about twice a width of the locking hinge on an edge, when present, and wherein the folding hinges are adapted to rotate the metallic or semiconducting elements to a desired angle to form an open, flexible structure configured to fold around the polyhedron or particle, and if one or more locking hinges are present, the interconnected two-dimensional metallic or semiconducting elements are permanently held together by solid hinges while folded around the polyhedron or particle, and wherein the antenna structure is capable of receiving and/or transmitting electromagnetic energy.

The presently disclosed antenna structures can be fabricated from or include at least one material selected from the group consisting of a metal (meaning an element that is solid, has a metallic luster, is malleable and ductile, and conducts both heat and electricity), a polymer, as that term is known in the art, a glass (meaning a brittle transparent solid with irregular atomic structure), a semiconductor (meaning an element, such as silicon, that is intermediate in electrical conductivity between conductors and insulators, through which conduction takes place by means of holes and electrons), and an insulator (meaning a material that is a poor conductor of heat energy and electricity).

In some embodiments, the interconnected metallic or semiconducting elements comprise a metal selected from the group consisting of aluminum, nickel, copper, gold, and silver. In further embodiments, the interconnected metallic or semiconducting elements are coated with a material selected from the group consisting of a metal, a polymer, a dielectric material, and combinations thereof.

As used herein, the term “dielectric” refers to an electrical insulating material that possesses a high polarizability. Dielectric materials can be a solid, liquid, or gas, or in some cases, a high vacuum. Non-limiting examples of a solid dielectric material include ceramic materials, such as porcelain, a glass, a plastic, and an inorganic dielectric. Non-limiting examples of liquid dielectric materials include mineral oil and castor oil. Non-limiting examples of gaseous dielectric materials include air, nitrogen, and sulfur hexafluoride. An inorganic dielectric can include aluminum oxide (Al₂O₃). Further, dielectric coatings can include the parylenes, e.g., poly(p-xylylene)polymers.

Accordingly, in some embodiments of the presently disclosed antenna structure, the dielectric material is selected from the group consisting of a dielectric gas, a dielectric polymer, and an inorganic dielectric material.

In some embodiments, the interconnected metallic or semiconducting elements comprise a two-dimensional geometry selected from the group consisting of a square, a rectangle, a triangle, a circle, and parts, and combinations thereof. As used herein the term “parts” in reference to a two-dimensional geometry refers, for example, to a “part” of a circle, e.g., a semi-circle, and the like.

One of ordinary skill in the art would recognize upon review of the presently disclosed subject matter that the interconnected metallic or semiconducting elements can comprises any geometric shape.

In particular embodiments, the antenna structure is capable of harvesting electromagnetic energy from an electromagnetic energy source. In representative embodiments, the antenna structure is capable of operating in the radio, microwave, infrared, and optical regions of the electromagnetic spectrum with wavelengths from about 6 mm to about 100 nm.

Radio wavelengths range from hundreds of meters to about one millimeter; microwave wavelengths range from about 1 meter to about 1 millimeter; infrared wavelengths range from about 1 mm to about 750 nm, including the far infrared (about 1 mm to about 10 μm), mid-infrared (about 10 μm to about 2.5 μm), and near infrared (about 2.5 μm to about 750 nm); and visible (or optical) wavelengths range from 750 nm to about 380 nm.

In some embodiments, the antenna structure can be used as a conductivity sensor. In other embodiments, the antenna structure can be used as an electromagnetic filter. In yet other embodiments, the antenna structure comprises a rectifier system, wherein the antenna structure is capable of acting as a rectenna.

As used herein, the term “rectenna” refers to an antenna that converts microwave or radiowave energy into direct current electricity. Rectennas typically are used in wireless power transmission systems that transmit power by radio waves.

In some embodiments, the antenna structure is isotropic or substantially isotropic, that is, it is uniform in all orientations and all directions, i.e., it exhibits physical and mechanical properties having the same values when measured along axes in any direction. In other embodiments, the antenna structure has a low polarization or a low directional dependence.

In some embodiments, the size, geometry, and/or material of the antenna structure can affect the electrical characteristics of the antenna. For example, by varying the size, geometry, and/or material of the antenna structure, its operating frequency and/or input impedance can be adjusted, changing the antenna's power rating, gain, efficiency, and any combinations thereof.

In some embodiments, the presently disclosed subject matter provides an electrically small antenna suitable for energy harvesting applications. In other embodiments, an electrically small antenna is combined with a rectifier, such as a 50 ohm rectifier, using an EM wave provided from an external source. In further embodiments, the electrically small antenna can be combined with a rectifier to power a small, for example 500×500×500 μm³, implantable device. One of ordinary skill in the art would recognize that implantable devices of different sizes are suitable for use with the presently disclosed antenna structures. In still further embodiments, an electrically small antenna is combined with a nonlinear rectifier.

While designing an implantable antenna for energy harvesting, one has to consider that the human body is not the ideal medium for EM signal propagation. The human body behaves as an irregular dielectric in which the electric field distribution depends on the physiological parameters of the body and the frequency and polarization of the incident EM wave (Chen, 2007; Anacleto et al., 2011). The power losses in the path between the external source and the implanted device can be calculated to fulfill the power requirements of the implanted device.

The propagation of EM waves in a dielectric material, such as human tissue, can be determined by its electrical parameters, electric permittivity, and electric conductivity, which determine the dielectric attenuation. Different mediums have different attenuation factors, which can be calculated as a function of frequency to determine the power loss of a signal when an antenna is placed either transdermal or deep inside the tissue.

The efficiency of a miniaturized antenna will increase by the use of higher frequencies since the antenna efficiency is directly proportional to its electrical size (Harrington, 1960). Power loss due to tissue attenuation, however, is more expressive at higher frequencies. It has been shown that the optimal frequency for wireless power transmission into a dispersive medium, such as human tissue, is in the low GHz range (Anacleto et al., 2011). It also has been previously shown that when an electrically small antenna, for example, an antenna confined in a 500×500×500 μm³ box, is embedded in dispersive tissue, the optimum operating frequency resides in the low GHz region because tissue attenuation dominates the overall efficiency in frequencies higher than 10 to 20 GHz, depending on the tissue type (Anacleto et al., 2011).

Thus, in some embodiments, the presently disclosed subject matter provides an implantable medical device comprising the presently disclosed antenna structure. Accordingly, the presently disclosed microantenna can be used in implantable medical devices suitable for use with a patient or subject in need of treatment with the particular device. The method further comprises techniques known in the art for implanting such devices in a subject. The subject treated by the presently disclosed methods in their many embodiments is desirably a human subject, although it is to be understood that the methods described herein are effective with respect to all vertebrate species, which are intended to be included in the term “subject.”

A “subject” can include a human subject for medical purposes, such as for the treatment of an existing condition or disease or the prophylactic treatment for preventing the onset of a condition or disease, or an animal subject for medical, veterinary purposes, or developmental purposes. Suitable animal subjects include mammals including, but not limited to, primates, e.g., humans, monkeys, apes, and the like; bovines, e.g., cattle, oxen, and the like; ovines, e.g., sheep and the like; caprines, e.g., goats and the like; porcines, e.g., pigs, hogs, and the like; equines, e.g., horses, donkeys, zebras, and the like; felines, including wild and domestic cats; canines, including dogs; lagomorphs, including rabbits, hares, and the like; and rodents, including mice, rats, and the like. An animal may be a transgenic animal. In some embodiments, the subject is a human including, but not limited to, fetal, neonatal, infant, juvenile, and adult subjects. Further, a “subject” can include a patient afflicted with or suspected of being afflicted with a condition or disease. Thus, the terms “subject” and “patient” are used interchangeably herein.

In other embodiments, the presently disclosed subject matter provides an electronic device comprising a presently disclosed antenna structure. The presently disclosed antenna structure is suitable for electronic integration.

In further embodiments, the presently disclosed subject matter provides an array comprising a plurality of the presently disclosed antenna structures. See, for example, Randhawa et al. (2010), which is incorporated herein by reference in its entirety. In some embodiments, the array comprises a metamaterial. As used herein, the term “metamaterial” refers to an assembly of multiple individual elements, of sub-wavelength sizes, arranged in a particular periodic pattern. Metamaterials typically gain their properties from their precise shape, geometry, size, orientation, and arrangement. For microwave radiation, the structures need only to be on the order of several millimeters.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter. The descriptions and specific examples that follow are only intended for the purposes of illustration, and are not to be construed as limiting in any manner to make compounds of the disclosure by other methods.

### Example 1

### High Frequency Structural Simulator (HFSS) Model

The presently disclosed micro antenna was designed and simulated with Ansoft HFSS v.12 (www.Ansys.com), which is a high frequency structural simulator model that utilizes the finite element technique for EM computation. The model is composed of a square loop antenna confined to a 500×500×500 μm³ air box (representing the micro device volume), which is surrounded by a 5×5×5 mm³ box with dielectric properties similar to that of human tissue, where a radiation boundary (containing the antenna loop) is applied at the surface of the box and the antenna is excited through a lumped port.

### Example 2

### Square Loop Antenna

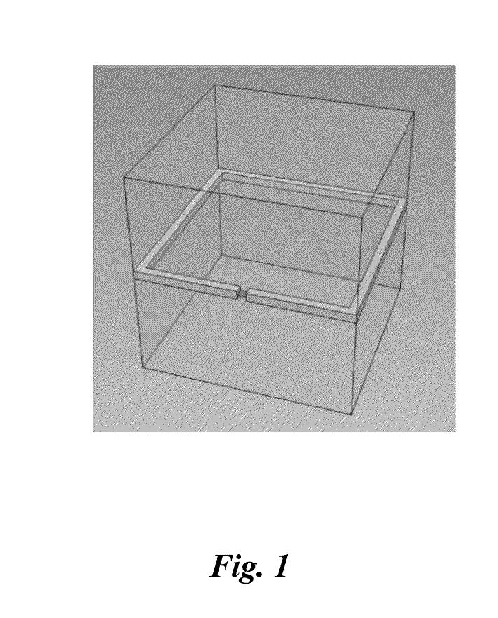

A 2D antenna (FIG. 1) was designed to fit on the microdevice. A square loop geometry was chosen since its simple design fits in the fabrication process restrictions and has a structure that maximizes the antenna size on a 500×500 μm² surface. A rectangular single loop was chosen over, for example, a rectangular coil, due to its fabrication and simulation simplicity and, in that way, establishing a primary design as a comparison base for future designs. The antenna has a total length of about 1.98 mm, with a 20×20 μm² cross-section. In this example, the antenna material is gold. As a result of its miniaturized size, the antenna efficiency peak occurs at the fundamental resonance of 163 GHz. Without wishing to be bound to any one particular theory, it is believed that power losses due to tissue attenuation tend to be more expressive at higher frequencies, where virtually no power can be wirelessly transmitted to the antenna because of severe tissue attenuation. Consequently, the input port impedance was selected to match the antenna impedance in the low gigahertz range (1-10 GHz), since the miniaturized antenna is not resonating at that frequency range.

The tissue layer surrounding the 500×500×500 μm³ microdevice is simulated as having human muscle tissue dielectric properties (conductivity, relative permittivity, and loss tangent) for the selected frequencies. Such values can be found in “Calculation of the Dielectric Properties of Body Tissues in the frequency range 10 Hz to 100 GHz” (http://niremf.ifac.cnr.it/tissprop/htmlclie/htmlclie.htm#stsftag).

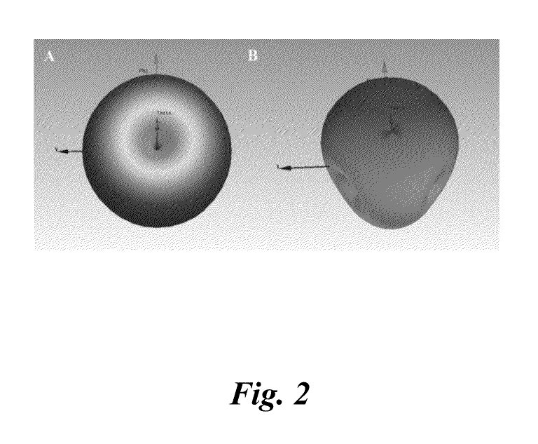

A range of frequencies, in the low GHz range, were tested to verify antenna parameters, such as efficiency, input impedance, return loss and bandwidth. FIG. 2A illustrates the common donut shaped radiation diagram of the loop antenna in free space, while FIG. 2B shows the effect of surrounding human tissue.

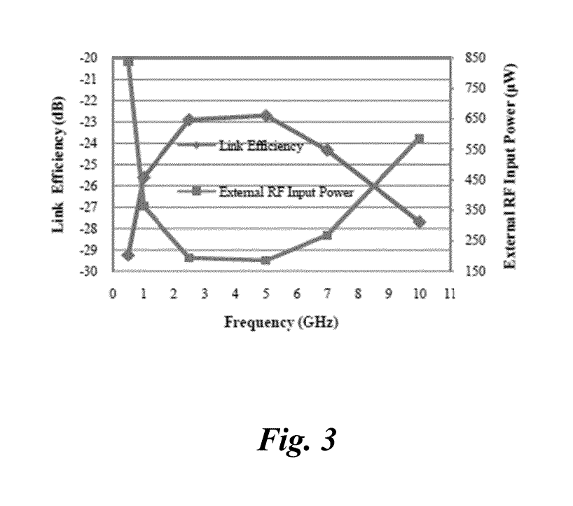

The simulation results of the square loop antenna between 0.5 and 10 GHz (FIG. 3) suggest that the optimum operating frequency window is between about 2.5 GHz and about 5 GHz, where the overall link efficiency and energy power transfer are maximized. The results also show that the external RF source must generate on the order of about hundreds of microwatts to fulfill the power requirement of the device; for example, at 5 GHz operating frequency, the RF source must provide 186 μW power to deliver 1 μW power to the microdevice. The power budget calculations were made considering a distance of 2.5 cm between an external source and the antenna and do not consider the rectifier RF-DC conversion efficiency.

### Example 3

### 3D Cubic Antenna

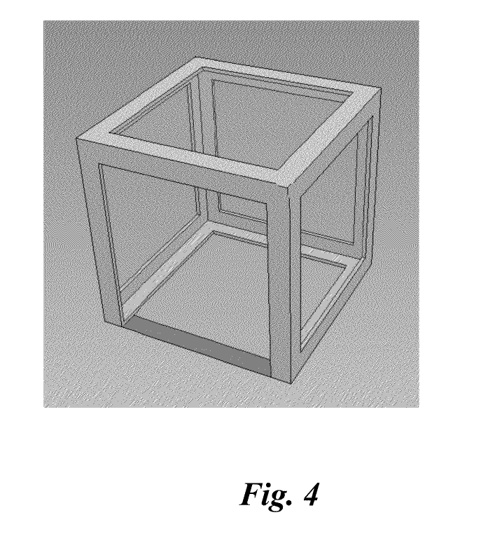

A second antenna with a cubic geometry enveloping the 500×500×500 μm³ microdevice was designed similar to the previous square loop antenna with the same 20×20 μm² cross section and a 20×20 μm² lumped port length. A first set of simulations showed that better link efficiency can be obtained by changing the antenna cross section to 50×10 μm² and increasing the lumped port length to 400 μm (FIG. 4). In FIG. 4, the portions of the structure on either side of the missing cube edge provide the input port of the antenna. Because each of the faces of the 3D cube antenna has substantially the same dimensions, the structure of the 3D cube antenna is substantially isotropic. Further, because the structure of the 3D cube antenna comprises elements that are substantially orthogonal to one another, the 3D cube antenna is less directional than antennas that include elements that are oriented in one direction only. As a result, the 3D cube antenna has low directional dependence.

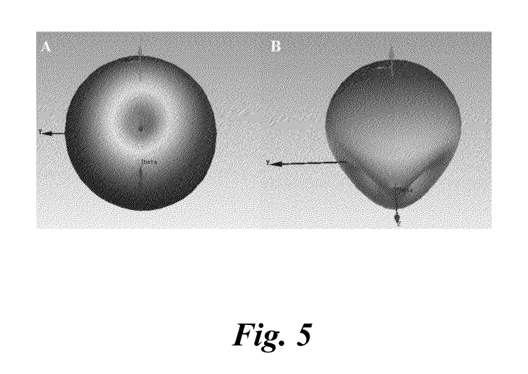

The previously described antenna tuning procedure was applied so that the antenna resonates at the same low GHz frequency range. FIG. 5A shows the donut shaped radiation diagram of the 3D antenna in free space while FIG. 5B shows the effect of the surrounding muscle tissue.

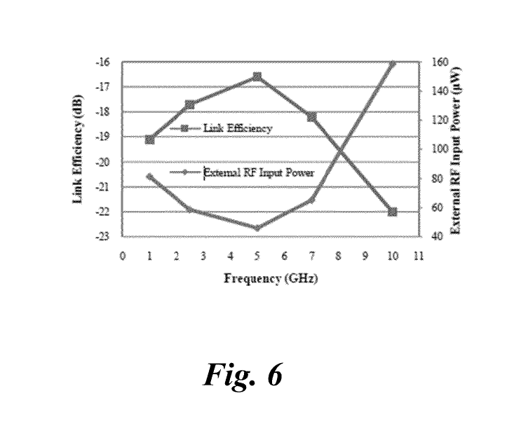

HFSS simulations (FIG. 6) show that the cubic design significantly improves the link efficiency compared to the square loop geometry. The results show 6.1 dB improvement in the overall link efficiency at the optimal frequency of 5 GHz, which means that the 3D antenna requires only 46 μW from the external RF source to satisfy the power requirements of the microdevice.

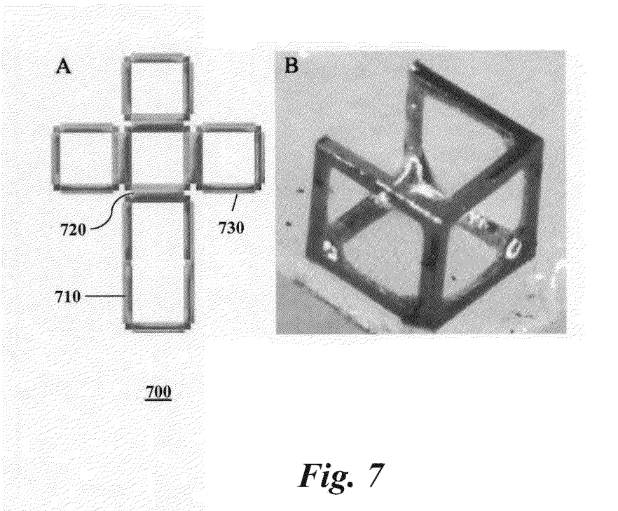

The first 3D antenna prototype (FIG. 7A and FIG. 7B) was fabricated by combining the surface tension driven self-folding technique with conventional multilayer photolithography. This combined technique allows precise patterning of 2D templates (FIG. 7A) that can transform into 3D complex structures (FIG. 7B) with higher surface area to volume ratios.

Referring now to FIG. 7A is 2D template 700, which comprises a plurality of interconnected two-dimensional metallic or semiconducting elements 710 comprising a folding hinge 720 between two adjacent metallic or semiconducting elements and optionally a locking hinge 730 on an edge of a metallic or semiconducting element.

### Example 4

### Other 3D Antennas

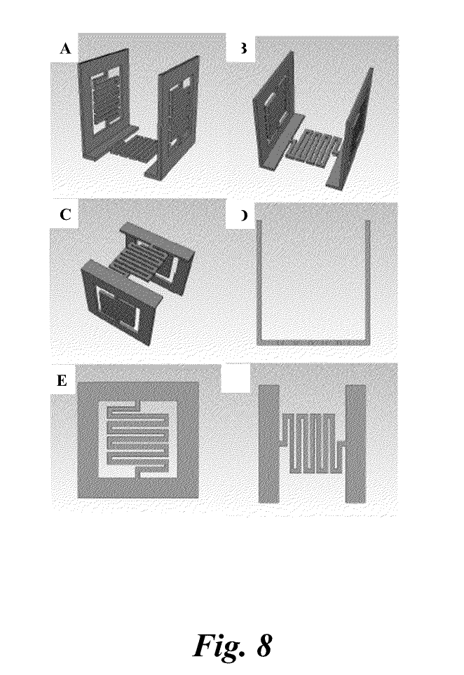

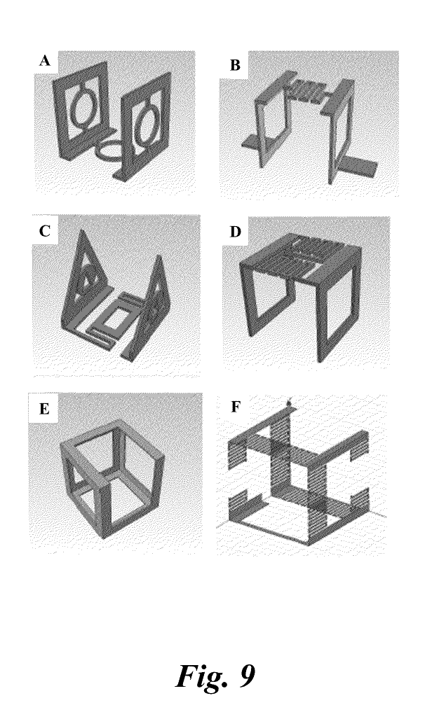

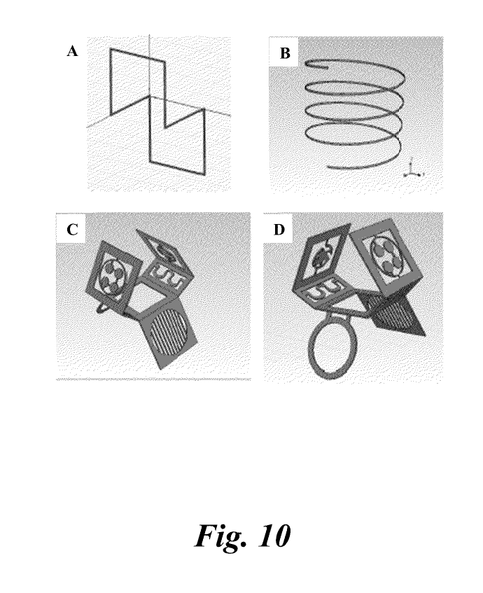

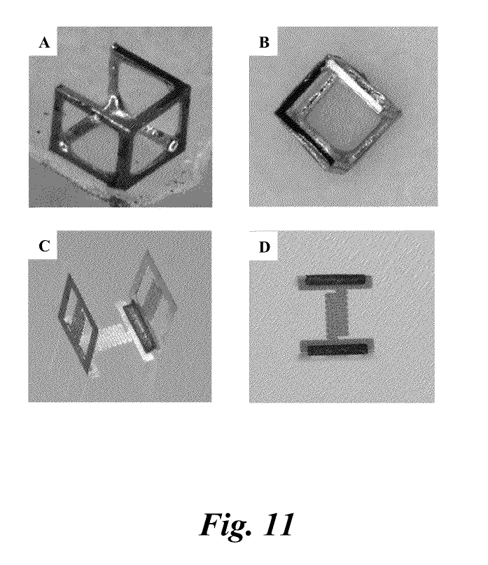

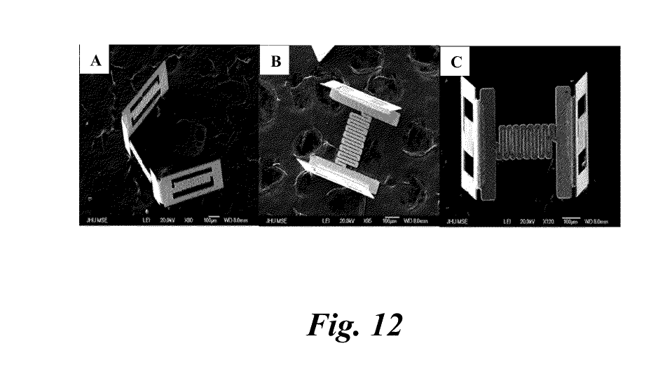

Representative configurations of the presently disclosed 3D microantennas as provided in FIGS. 8-12.

### Example 5

### Conclusion

For small antennas, high frequencies in the range of hundreds of GHz have been widely used since the efficiency of the antenna is directly proportional to the ratio of the antenna size and the wavelength of the signal. At these high frequencies, however, tissue attenuation is very severe, and virtually no power can be transferred to the antenna when it is used to harvest energy for an implanted microdevice. Considering an implanted device with low power requirements, on the order of the microwatts, HFSS simulations and the power calculations suggest that it is possible to transfer enough energy in the low GHz range.

The presently disclosed design and simulations suggest that such 3D antennas can increase the efficiency of the antenna at least four times as compared to planar antennas, i.e., 2D antennas, without increasing the size of the implant. Further, different 3D antenna shapes that vary the antenna electrical characteristics and maximize the antenna efficiency.

Further, presently disclosed 2D and 3D antennas may be used in combination with certain other circuits and/or devices. Namely, because the presently disclosed 2D and 3D antenna structures can be formed on a substrate via standard lithography processes, the 2D and 3D antenna structures can be formed alongside other electrical circuits and/or devices on the same substrate. In one example, a conductivity sensor can be formed that comprises the presently disclosed 2D and 3D antennas. A conductivity sensor is a device that measures the conductivity of, for example, aqueous solutions. In another example, an electromagnetic filter can be formed that comprises the presently disclosed 2D and 3D antennas. An electromagnetic filter is a device used to suppress certain electromagnetic energy. In yet another example, a rectifier system can be formed that comprises the presently disclosed 2D and 3D antennas wherein the antenna structures are capable of acting as rectennas. A rectenna is a rectifying antenna, which a type of antenna that is used to convert microwave energy into electricity.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.
Anacleto P., Gultepe E., Gracias D., Correia J. H., Mendes P. M. “Antenna operating frequency selection for energy harvesting on nano bio medical devices”. 41st European Microwave Conference. 2011. pp: 64-66;
Ahmadi, M. M., Jullien, G. A., “A Wireless-Implantable Microsystem for Continuous Blood Glucose Monitoring”, IEEE Transactions on Biomedical Circuits and Systems, Vol. 3, 3, 2009. pp: 169-180;
Biomat.net Newsletter, Issue 9, Vol. 12, 6. 2011;
Chen, Z. N. Antennas for Portable Devices: John Wiley & Sons. 2007;
Chow, E. Y.; Chlebowski, A. L.; Irazoqui, P. P. “A Miniature Implantable RF-Wireless Active Glaucoma Intraocular Pressure Monitor”. IEEE Transactions on Biomedical Circuits and Systems, Vol. 4, 6. 2010. pp: 340-349;
Chow, E. Y., Ouyang, Y., Beier, B., Chappell, W. J., Irazoqui, P. P. “Evaluation of Cardiovascular Stents as Antennas for Implantable Wireless Applications”. IEEE Transactions on Microwave Theory and Techniques. Vol. 57, 10. 2009. pp: 2523-2532;
Fu, X., Chen, W., Ye, S., Tu, Y., Tang, Y., Li, D., Chen, H., Jiang, K. “A Wireless Implantable Sensor Network System for In Vivo Monitoring of ECG Physiological Signals”. IEEE Transactions on information technology in Biomedicine. Vol. 15, 4. 2011;
Gabriel S., Lau R. W. and Gabriel C., The dielectric properties of biological tissues: III. Parametric models for the dielectric spectrum of tissues. Phys. Med. Biol. 41, 2271-93, 1996;
Gracias, D. H., Stimuli responsive self-folding using thin polymer films, Current Opinion in Chemical Engineering 2, 112-119 (2013).
Harrington, R. F. “Effect of Antenna Size on Gain, Bandwidth, and Efficiency”. Journal of Research of the National Bureau of Standards-DRadio Propagation, Vol. 51, 1960;
Huang, F., Lee, C., Chang, C., Chen, L., Yo, T., Luo, C. “Rectenna Application of Miniaturized Implantable Antenna Design for Triple-Band Biotelemetry Communication”. IEEE Transactions on Antennas and Propagation. Vol. 59, 7. 2011. pp: 2646-2653;
Jabbar, H., Song, Y. S., Jeong, T. T. “RF Energy Harvesting System and Circuits for Charging of Mobile Devices”. IEEE Transactions on Consumer Electronics. Vol. 56, 1. 2010;
Lee, S., Hwang, T., Kim, Y., Chung, H. “Implementation of Implantable Cardioverter Defibrillator”. International Symposium on Communications and Information Technology. 2009. pp: 845-848;
Leong, T. G., Benson, B. R., Call, E. K., Gracias, D. H., Thin film stress driven self-folding of microstructured containers, Small 4(10), 1605-1609 (2008);
Miura, Y., Hachida, T., Kimura, M. “Artificial Retina Using Thin-Film Transistors Driven By Wireless Power Supply”. IEEE Sensors Journal, Vol 11, 7. 2011. pp: 1564-1567;
Nishimoto, H., Kawahara, Y., Asami, T. “Prototype Implementation of Ambient RF Energy Harvesting Wireless Sensor Networks”. IEEE Sensors Conference. 2010. pp: 1282-1287;
Randhawa, J. S, Gurbani, S. S., Keung, M. D., Demers, D., Leahy-Hoppa, M. R., Gracias, D. H., Three-dimensional surface current loops in terahertz responsive microarrays, Applied Physics Letters 96, 19, 191108/1-3 (2010);
Nuxoll, E. E., Siegel, R. A. “BioMEMS Devices for Drug Delivery”. IEEE Eng Med Biol Mag, Vol. 28. 2009;
Olivo, J., Carrara, S., De Micheli, G. “Energy Harvesting and Remote Powering for Implantable Biosensors”. IEEE Sensors Journal. Vol. 11, 7. 2011. pp: 1573-1586;
Peng, C., Chaimanonart, N., Ko, W. H., Young, D. J. “A Wireless and Batteryless 10-Bit Implantable Blood Pressure Sensing Microsystem With Adaptive RF Powering for Real-Time Laboratory Mice Monitoring”. IEEE Journal of Solid-State Circuits. Vol. 44, 12. 2009. pp: 3631-3644;
Poon, A. S. Y., O'Driscoll, S., Meng, T. H. “Optimal Frequency for Wireless Power Transmission Into Dispersive Tissue”, IEEE Transactions on Antenna and Propagation. Vol. 58, 5. 2010;
Rahimi, S., Sarraf, E. H., Wong, G. K., Takahata, K. “Implantable drug delivery device using frequency-controlled wireless hydrogel microvalves”. Biomedical Microdevices, Vol. 13, 2. 2011. pp: 267-277;
Randall, C. L., Gultepe, E., Gracias, D. H. 2011. “Self-folding devices and materials for biomedical applications”. Trends in Biotechnology, Vol. 30, 2012. pp: 138-146;
Wise, K. D., Sodagar, A., Yao, Y., Gulari, M. N., Perlin, G. E., Najafi, K. “Microelectrodes, Microelectronics and Implantable Neural Microsystems”. Proceedings of the IEEE. Vol. 96, 7. 2008. pp: 1184-1202;
Yang, C.; Tsai, C.; Cheng, K.; Chen, S. “Low-invasive implantable devices of low power consumption using high efficiency antenna for cloud health care”. IEEE Journal on Emerging and Selected Topics in Circuits and Systems. Vol. 2, 1. 2012, pp: 14-23;
Yang, Y., Huang, Y., Liao, H., Wang, T., Huang, P., Lin, C., Wang, Y., Lu, S. “A release-on-demand wireless CMOS drug delivery SoC based on electrothermal activation”. IEEE International Solid-State Circuits Conference. 2009. pp: 288-289; and
Yekeh, K., Kohno, R. “Wireless Communications for Body Implanted Medical Device”. APMC Microwave Conference 2007. pp: 1-4.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. An antenna structure comprising a plurality of interconnected two-dimensional metallic or semiconducting elements self-folded around a sub-millimeter scale dielectric polyhedron or sub-millimeter scale particle.

2. The antenna structure of claim 1, wherein the plurality of interconnected two-dimensional metallic or semiconducting elements comprise a folding hinge between two adjacent metallic or semiconducting elements and optionally a locking hinge on an edge of a metallic or semiconducting element, wherein the folding hinge comprises one or more of the materials selected from the group consisting of a liquefiable or coalescing material, a thin film, a residually stressed bilayer, a thermally stressed bilayer, a stimuli responsive material, a polymer bilayer, and a polymer gradient.

3. The antenna structure of claim 1, wherein the plurality of interconnected two-dimensional metallic or semiconducting elements are built on a dielectric element which can curve or self-fold due to the stress gradient or differential stress over the whole structure.

4. The antenna structure of claim 1, wherein the interconnected metallic elements comprise a metal selected from the group consisting of aluminum, nickel, copper, gold, and silver.

5. The antenna structure of claim 1, wherein the interconnected semiconducting elements comprise a semiconductor selected from the group consisting of silicon, gallium arsenide, germanium, and indium arsenide.

6. The antenna structure of claim 4, wherein the interconnected metallic elements are coated with a material selected from the group consisting of a metal, a polymer, a dielectric material, and combinations thereof.

7. The antenna structure of claim 6, wherein the dielectric material is selected from the group consisting of a dielectric gas, a dielectric polymer, and an inorganic dielectric material.

8. The antenna structure of claim 1, wherein the antenna structure is capable of harvesting electromagnetic energy from an electromagnetic energy source.

9. The antenna structure of claim 1, wherein the antenna structure is capable of operating in the radio, microwave, infrared and optical regions of the electromagnetic spectrum with wavelengths from about 6 mm to about 100 nm.

10. The antenna structure of claim 1, wherein the antenna structure is isotropic or substantially isotropic.

11. The antenna structure of claim 1, wherein the antenna structure has a low directional dependence.

12. The antenna structure of claim 1, wherein the interconnected metallic or semiconducting elements comprise a two-dimensional geometry selected from the group consisting of a square, a rectangle, a triangle, a circle, and parts and combinations thereof.

13. The antenna structure of claim 1, wherein varying one or more materials, dimensions and/or geometry of the antenna structure allows varying one or more electrical characteristics of the antenna.

14. An implantable medical device comprising an antenna structure of claim 1.

15. An electronic device comprising an antenna structure of claim 1.

16. The electronic device of claim 15, wherein the electronic device comprises a conductivity sensor.

17. The electronic device of claim 16, wherein the electronic device comprises an electromagnetic filter.

18. The antenna structure of claim 1, further comprising a rectifier system, wherein the antenna structure is capable of acting as a rectenna.

19. An array comprising a plurality of antenna structures of claim 1.

20. The array of claim 19, wherein the array comprises a metamaterial.
